(19) United States
(12) Patent Application Publication
(10) Pub. No.: US 2005/0103420 A1
(43) Pub. Date: May 19, 2005

(54) Attachment method of pressed flowers

(76) Inventor: Mei Hui Chen, San Marino, CA (US)

Correspondence Address: Leong C. Lei;PMB#1008, 1867 Ygnacio Valley Rd., Walnut Creek, CA, 94598-3214, US

(21) Appl. No.: 10/706,916

(22) Filed: Nov. 14, 2003

(51) Int. Cl. B32B 31/00

(52) U.S. Cl. 156/57

(57) ABSTRACT

A attachment method for pressed flowers which includes the steps of: covering pressed flowers with a layer of transparent resin which becomes sticky when heated, attaching said pressed flowers to a surface of a base material, and indirectly heating said pressed flowers to make said resin become sticky thereby firmly adhering said pressed flowers to said base material without the use of adhesive and therefore making it easier and more convenient for decoration. It is also very convenient to separate the flower from the base material and heat it indirectly again to attach to another base material. The resin coating the flowers has the additional benefits of preventing the pressed flowers from color fading, wear and tear, and extending their usage.

### BACKGROUND OF THE INVENTION

1. Field of the Invention

This invention is related to the creation of an attachment technology for pressed flowers, and in particular to one which has no need for adhesives, thereby making flower decoration easier, more convenient, and for the pressed flowers to be re-used many times.

2. Description of the Prior Art

As shown in FIG. 1, the conventional method of pressing flowers is to make the pressed flowers 100 flat, (including flower, bud, leaf, stem, fruits and seedlings, etc) put them through a drying treatment so that they will retain their original color, (see FIG. 1) then cover the surface of the flowers 100 with adhesive 200, and attach the adhesive 200 onto the base material 300 (such as paper fabric, card, wood, leather, plastic, etc.). Before being attached to the base materials, the flower 100 must be wholly or partly covered with adhesive 200 on its back side. Not only is the process complicated and slow, but in addition the flowers cannot be separated from their base materials, and the flowers have no cover for protection, so the flowers easily become faded, worn out and their time of usage greatly reduced.

Accordingly, it is an object of the present invention to provide an attachment method for pressed flowers which can mitigate and obviate the above-mentioned drawbacks.

### SUMMARY OF THE INVENTION

Accordingly, it is an object of the present invention to provide an attachment method for pressed flowers, whereby the entire pressed flowers are coated with transparent resin on its both sides. When the resin is heated indirectly, it becomes sticky, so the flowers can be attached to the base materials (such as card, wood, leather, plastic, etc), without the use of adhesive.

Another object of the present invention is to provide an attachment method wherein the pressed flowers being attached are protected from wear and tear, and color fading.

Yet another object of the present invention is to provide an attachment method for pressed flowers which enables the pressed flowers to be re-used, and their usage period extended.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-section view of the attachment method of the prior art

FIG. 2 is a plane section view of the attachment method of the present invention.

FIG. 3 is a cross-section view of the attachment method of the present invention.

FIG. 4 is a cross-section view of indirect heating and separating of the resin from the non-adhesive plate.

FIG. 5 is a sectional view of the combination method of attachment.

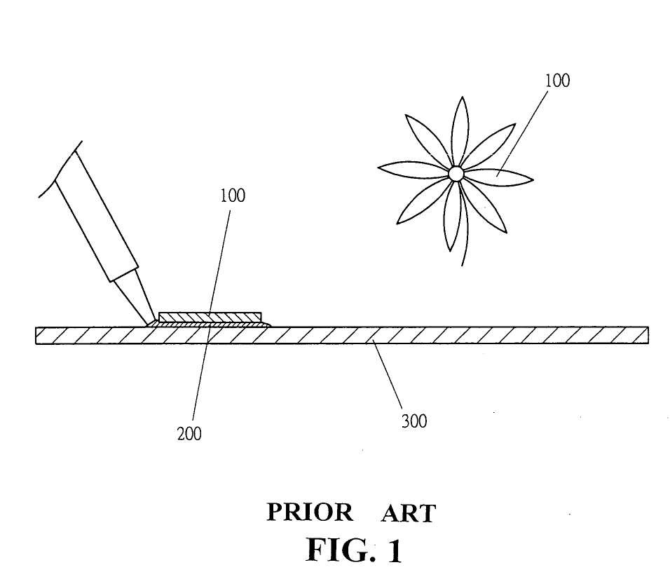

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

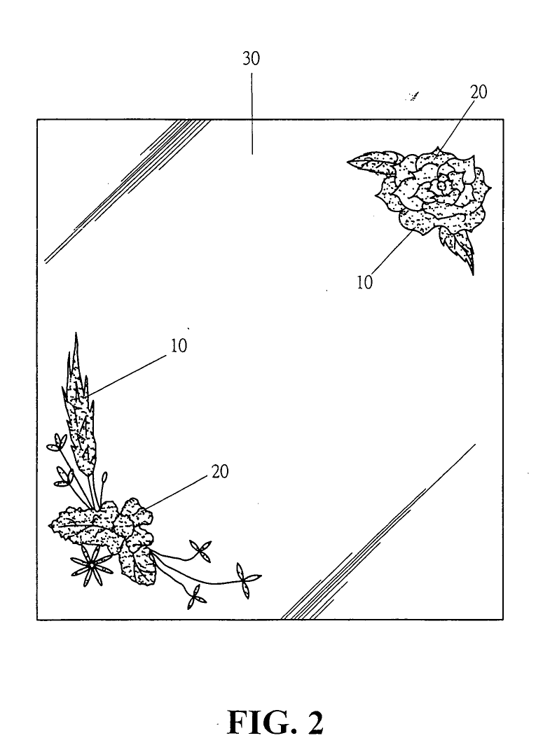

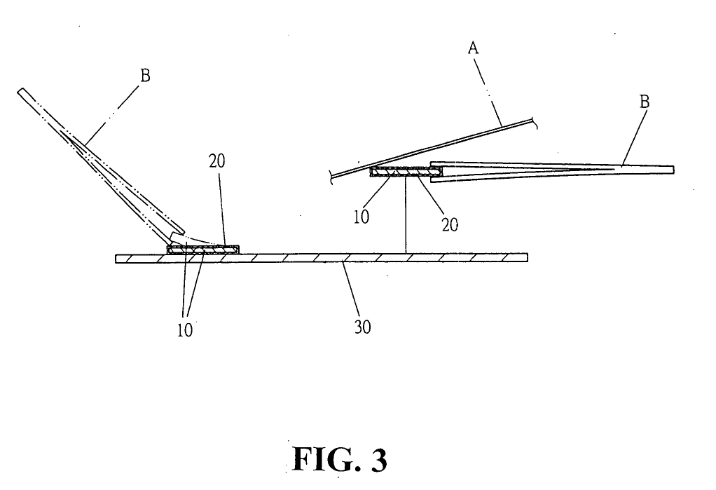

Referring to FIG. 2, the flower materials (including flower, bud, leaf, stem, fruit and seedlings, etc) are first collected and put through a drying treatment to retain their original color to form pressed flowers 10. Then pressed flowers 10 are covered with transparent resin 20, which becomes sticky when heated (See FIG. 3).

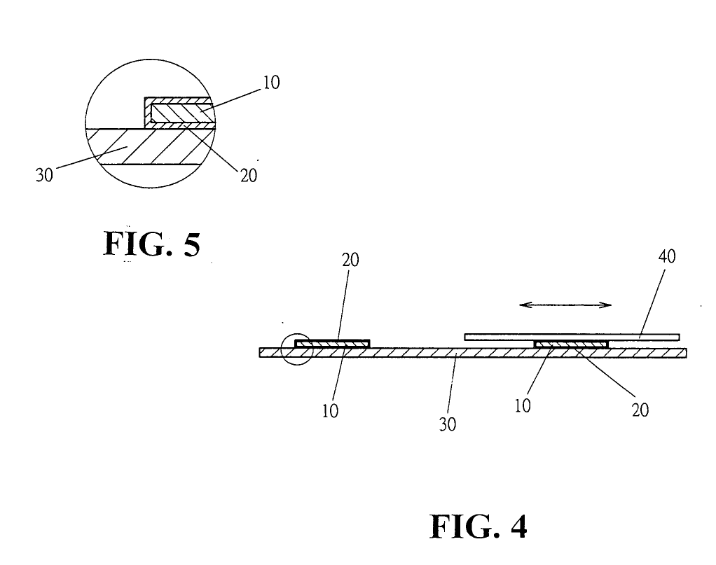

The pressed flowers 10 can then be attached by the user on the release paper A in advance and a hand tool B or one's fingers can be used to separate the flowers 10 from the release paper A (see FIG. 3). Then, the flowers 10 are attached to the surface of base material 30 (paper fabric, card, wood, leather, plastic, etc) and covered with a non-adhesive plate 40 (see FIG. 4) and heated indirectly, to make the resin 20 sticky so that the flowers 10 will stick onto the base material 30. The transparent resin 20 is not attached to the non-adhesive plate 40, so the non-adhesive plate 40 can be removed easily, leaving the flowers 10 attached to the base materials 30. The flowers 10 will then be visible through the resin 20 to produce a decorative effect (see FIG. 5). In addition, the covering resin 20 enables the pressed flowers 10 to be protected from color fading, wear and tear, and their usage be extended.

The fingers can be used to rub the non-adhesive plate 40 to produce heat or an iron can be utilized to press the non-adhesive plate 40 to produce heat to enable transparent resin 20 to become sticky, so that the flowers 10 can be stuck securely onto the base materials 30. When the flowers 10 need to be separated from the base materials 30, a hand tool B or the fingers may be used to remove the flowers 10 from the base materials 30 (see FIG. 3.). Then the flowers 10 may be frequently attached onto other base materials.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A attachment method for pressed flowers comprising steps of:
a. covering pressed flowers with a layer of transparent resin which becomes sticky when heated;
b. attaching said pressed flowers to a surface of a base material;
c. indirectly heating said pressed flowers to make said resin become sticky thereby firmly adhering said pressed flowers to said base material.

2. The attachment method for pressed flowers as claimed in claim 1, wherein said indirectly heating refers using a non-adhesive plate to cover said transparent resin and then using fingers to rub said non-adhesive plate to produce heat to enable said transparent resin to become sticky.

3. The attachment method for pressed flowers as claimed in claim 1, wherein said indirectly heating refers using a non-adhesive plate to cover said transparent resin and then using a heated iron to press said non-adhesive plate so as to make said transparent resin to become sticky.
